(19) United States
(12) Patent Application Publication
(10) Pub. No.: US 2014/0370808 A1
(43) Pub. Date: Dec. 18, 2014

(54) NEGATIVE ION WIRELESS ACCESSORY

(71) Applicant: Red Fox Trading, Inc ( DBA: Dr. Ion USA), Los Angeles, CA (US)

(72) Inventor: Khan Hwang, Los Angeles, CA (US)

(21) Appl. No.: 13/919,925

(22) Filed: Jun. 17, 2013

(51) Int. Cl. H04M 1/725

(52) U.S. Cl. CPC H04M 1/7253
USPC 455/41.2

(57) ABSTRACT

A negative ion wireless accessory. The negative ion wireless accessory includes an anion emitting ornament. The negative ion wireless accessory also includes an auxiliary device attached to the anion emitting ornament and configured to establish a wireless connection to communicate with an external device.

### CROSS-REFERENCE TO RELATED APPLICATIONS

Not applicable.

### BACKGROUND OF THE INVENTION

Electronic devices have become extremely common place. Mobile devices especially have become almost ubiquitous in modern life. They allow users to communicate via phone, email, text, chat, connect to the Internet and perform many other desired tasks wherever they go. This has spawned related industries such as cell phone accessories that have become quite popular as they allow users to get the most from these mobile devices.

However, there are some drawbacks to the prevalence of these devices in our lives. For example, mobile devices are fairly easy to lose. I.e., many users put down a mobile device and walk away. The device is then stolen or lost. If others retrieve the mobile device they can use it to harm the owner. For example, the mobile device may include personal information or financial information that can be used against the owner.

In addition, many users are wary of placing mobile devices, such as cell phones near their head. In particular, the cell phone may simultaneously be connected to a cell tower, a Wi-Fi connection, a Bluetooth connection and other wireless connections. The effect of this radiation on the body remains unknown and many users are, therefore, reluctant to place these devices near their heads.

Accordingly, there is a need in the art for a device which can allow the user to access a mobile device or other electronic device from a remote location. Further there is a need in the art for the accessory to notify the user if he/she becomes separated from the mobile device. Additionally, there is a need in the art for an accessory that provides health benefits.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a negative ion wireless accessory. The negative ion wireless accessory includes an anion emitting ornament. The negative ion wireless accessory also includes an auxiliary device attached to the anion emitting ornament and configured to establish a wireless connection to communicate with an external device.

Another example embodiment includes a negative ion wireless accessory. The negative ion wireless accessory includes an anion emitting ornament. The negative ion wireless accessory also includes an auxiliary device attached to the anion emitting ornament. The auxiliary device includes a Bluetooth module configured to establish a Bluetooth connection between the auxiliary device and an external device, allowing the auxiliary device to communicate electronically with the external device.

Another example embodiment includes a negative ion wireless accessory. The negative ion wireless accessory includes an anion emitting ornament. The negative ion wireless accessory also includes an auxiliary device attached to the anion emitting ornament. The auxiliary device includes a Bluetooth module configured to establish a Bluetooth connection between the auxiliary device and an external device, allowing the auxiliary device to communicate electronically with the external device. The auxiliary device also includes an input configured to allow a user to input commands and a logic device. The auxiliary device further includes a memory and a power source.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a first example of a negative ion wireless accessory;

FIG. 1B illustrates a second example of a negative ion wireless accessory; and

FIG. 2 is a block diagram of an auxiliary device.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

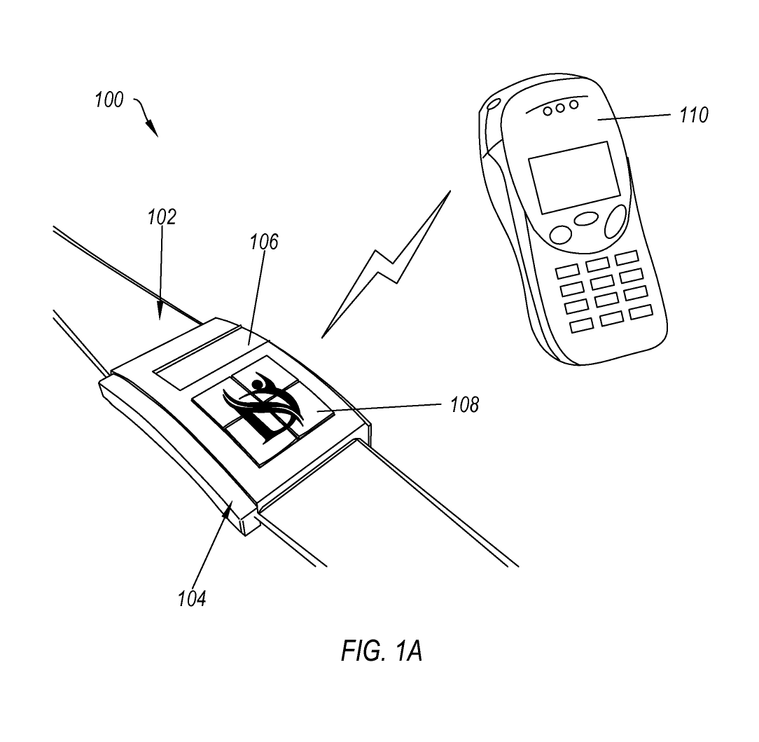

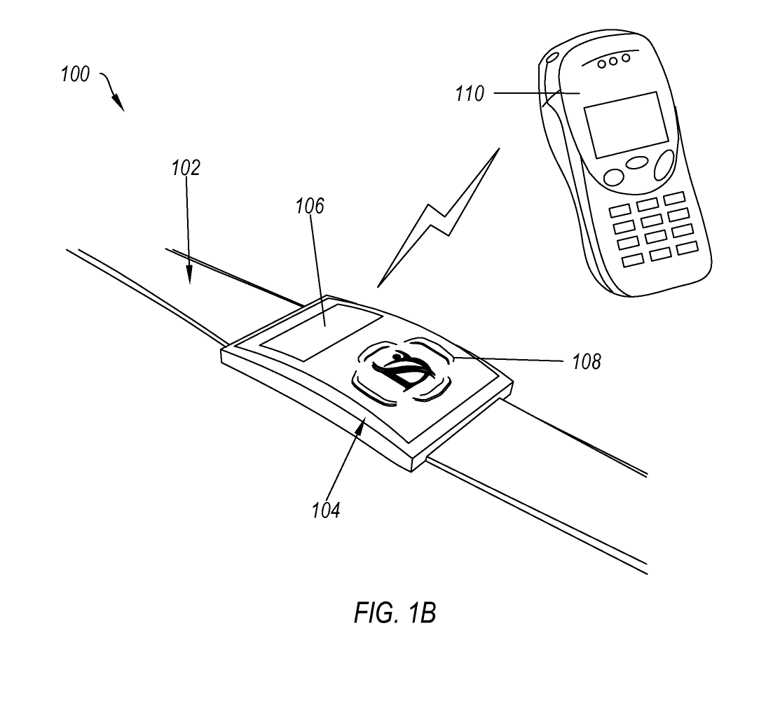

FIGS. 1A and 1B illustrate an example of a negative ion wireless accessory 100. FIG. 1A illustrates a first example of a negative ion wireless accessory 100; and FIG. 1B illustrates a second example of a negative ion wireless accessory 100. The negative ion wireless accessory 100 can be worn by the user in order to provide health benefits.

FIGS. 1A and 1B show that the negative ion wireless accessory 100 can include an anion emitting ornament 102. For example, the anion emitting ornament 102 can include a wristband, necklace, belt, jewelry or any other desired anion emitting ornament. One of skill in the art will appreciate that although a wristband is used for the example of the anion emitting ornament 102 herein, the principles disclosed are the same for other anion emitting ornaments.

The anion emitting ornament 102 can emit more than 2200 ions per cubic centimeter per second on average. For example, the anion emitting ornament 102 can include natural stones or ores that contain rare earth elements (REEs) or rare earth metals, as defined by IUPAC. I.e., the anion emitting ornament 102 can include any desired combination of REEs. REEs are a set of seventeen chemical elements in the periodic table. The REEs emit anions (negative ions) which help improve energy and power in human bodies, improve performance in sports activities (such as swings and hitting distances in golf), extract the maximum power hidden in human bodies, prevent snoring and sleep disorders (such as insomnia), relieve stress, prevent asthma, reduce pain (such as neck, shoulder, wrist and back pain), and produce other beneficial effects. Negative ions increase the flow of oxygen in the bloodstream including to the brain, resulting in higher alertness, more mental energy and reduced drowsiness. Negative ions also support the regulation of a healthy metabolism that will increase the vitality of the body.

FIGS. 1A and 1B also show that the negative ion wireless accessory 100 can include an auxiliary device 104. The auxiliary device 104 can include any device configured to connect to an external device via a wireless connection and/or provide a desired function. E.g., the auxiliary device can connect via Wi-Fi, Bluetooth or any other desired wireless connection to an external device. For example, the auxiliary device 104 can include a caller id, speaker, a display, headphone jack, distance indicator, clock, contactless device (such as personal identification, credit card, debit card), phone accessory, microphone, or any other desired device.

FIGS. 1A and 1B further show that the auxiliary device 104 can include a display 106. The display 106 can include any device capable of displaying images. For example, the display 106 includes a surface for images to be shown and display circuitry which broadcasts an image, or series of images, that are shown on the display 106.

FIGS. 1A and 1B additionally show that the auxiliary device 104 can include a control array 108. The control array 108 can include a set of buttons or other controls that allow a user to input commands. For example, the control array 108 can include direction pads, analog sticks, buttons, touch screens or any other desired input.

FIGS. 1A and 1B moreover show that the auxiliary device 104 can be in communication with an external device 110. The external device 110 can include any device capable of wireless connectivity. For example, the external device 110 can include a cell phone, computer, tablet, laptop, ultrabook or any other desired device.

In at least one implementation, if the auxiliary device 104 and the external device 110 separated from each other by a distance greater than a predetermined distance (e.g., long enough to interrupt the auxiliary device 104 and the external device 110), the auxiliary device 104 will emit a warning sound and/or a light signal to prevent loss of the connection. Additionally or alternatively, the warning sound and/or light signal can prevent loss of the external device 110 and/or the auxiliary device 104. I.e., the warning sound and/or light signal can act as a reminder to prevent the user from forgetting the external device 110 and/or the auxiliary device 104.

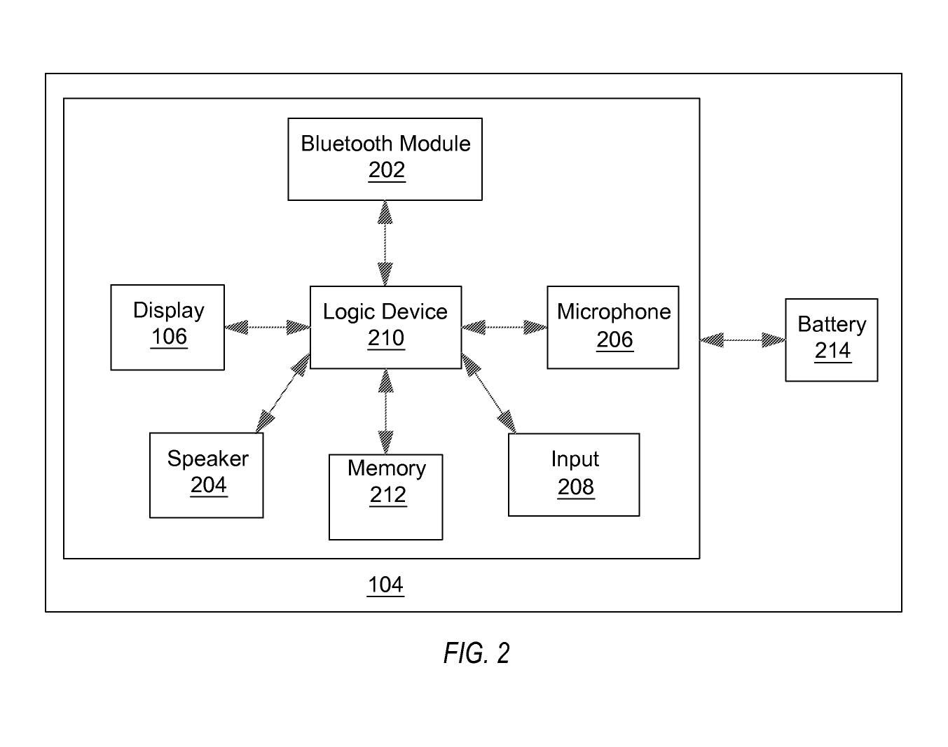

FIG. 2 is a block diagram of an auxiliary device 104. The auxiliary device 104 can be attached to a negative ion wireless accessory, such as the negative ion wireless accessory 100 of FIGS. 1A and 1B. Additionally or alternatively, the auxiliary device 104 can be a standalone device.

FIG. 2 shows that the auxiliary device 104 can include a Bluetooth module 202. For example, the Bluetooth module 202 can include a Bluetooth low energy (“BLE”) module. Bluetooth is an open wireless technology standard for exchanging data over short distances (using short-wavelength radio transmissions in the ISM band from 2400-2480 MHz) from fixed and mobile devices, creating personal area networks (PANs) with high levels of security. I.e., the Bluetooth module 202 allows data to be sent from the auxiliary device 104 to an external device and vice versa.

FIG. 2 also shows that the auxiliary device 104 can include a display 106. The display 106 can be made of glass, plastic or other material that allows the display circuitry to broadcast the image on one side of the display 106, while a user views the image from the other side of the screen. Additionally or alternatively, the display 106 can be a projection surface where the display circuitry can broadcast an image that is reflected to a user, who is on the same side of the display 106 as the display circuitry. One of skill in the art will appreciate that the location of the display circuitry relative to the display 106 and to the user is not limiting unless otherwise stated in the specification or the claims. For example, the display 106 can include television sets, computer monitors, video display panels, projectors, liquid crystal displays (“LCD”s) or light emitting diode (“LED”) displays. One of skill in the art will appreciate that the display 106 can include any other device that converts an electronic signal into an image unless otherwise stated in the specification or the claims.

FIG. 2 further shows that the auxiliary device 104 can include a speaker 204. The speaker 204 can include an electroacoustic transducer that converts an electrical signal into sound that can be perceived by a user. Specifically, the speaker 204 can move in accordance with the variations of an electrical signal and causes sound waves to propagate through a medium. In particular, the speaker 204 can be used to produce sound from a data signal sent to the auxiliary device 104. The speaker 204 can be part of the auxiliary device 104 or can be an external device such as external speakers. I.e., the speaker 204 can include devices, such as a headphone jack, which produces a signal to be sent to external speakers such as headphones.

FIG. 2 additionally shows that the auxiliary device 104 can include a microphone 206. The microphone 206 can include an acoustic-to-electric transducer or sensor that converts sound into an electrical signal. I.e., the microphone 206 can include a device which converts sound into an electrical signal for recordation and/or transmission over a network. The microphone 206 can use electromagnetic induction (dynamic microphone), capacitance change (condenser microphone), piezoelectric generation, or light modulation to produce an electrical voltage signal from mechanical vibration.

FIG. 2 moreover shows that the auxiliary device 104 can include an input 208. The input 208 can include any device configured to receive commands from a user. For example, the input 208 can receive commands from the control array 108 of FIGS. 1A and 1B. Additionally or alternatively, the input 208 can allow a user to plug in an input device, such as a keyboard, microphone, etc. For example, the input 208 can include a USB port or other connection port which allows the auxiliary device 104 to be connected to a computer or other external device via a hardwired or wireless connection.

FIG. 2 also shows that the auxiliary device 104 can include a logic device 210. A logic device 210 can include any device capable of performing logic functions. For example, the logic device 210 can perform Boolean logic or can produce a pre-determined output based on input. The logic device 210 can include ROM memory, programmable logic device (PLD), programmable array logic (PAL), generic array logic (GAL), complex programmable logic device (CPLD), field programmable gate arrays (FPGA), logic gates, processors or any other device capable of performing logic functions.

The logic device 210 can control the functions of the other components of the auxiliary device 104. In particular, the logic device 210 can ensure that the components of the auxiliary device 104 perform their desired function at the appropriate time and in the appropriate manner. The timing of functions can be critical to ensure that the electronic device is in communication with the auxiliary device 104 and that the auxiliary device 104 provides data as quickly as possible to the electronic device.

The logic device 210 can free the processor or controller of the external device to perform other tasks. Additionally or alternatively, the logic device 210 can ensure that enough resources are available to the auxiliary device 104 to reduce or eliminate lag time for commands. In particular, the logic device 210 can be used for processing commands input from a user and communicating the commands to the external device.

For example, the logic device 210 can include a microcontroller. A microcontroller (sometimes abbreviated μC, uC or MCU) is a small computer on a single integrated circuit containing a processor core, memory, and programmable input/output peripherals. Program memory in the form of NOR flash or one time programable ROM is also often included on chip, as well as a typically small amount of RAM. Microcontrollers will generally have the ability to retain functionality while waiting for an event such as a button press or other interrupt; power consumption while sleeping (CPU clock and most peripherals off) may be just nanowatts, making many of them well suited for long lasting battery applications.

FIG. 2 further shows that the auxiliary device 104 can include a memory 212. The memory 212 can include any device capable of storing data in computer readable form. The memory 212 can include volatile memory and non-volatile memory. Volatile memory can include dynamic random access memory (DRAM), static random access memory (SRAM), thyristor random access memory (T-RAM), zero capacitor random access memory (Z-RAM), twin transistor random access memory (TTRAM), delay line memory, selectron tube and williams tube. Non-volatile memory can include read-only memory (ROM), programmable read only memory (PROM), erasable programmable read only memory (EPROM), electrically erasable programmable read only memory (EEPROM), flash memory, ferroelectric random access memory (FeRAM), magnetoresistive random access memory (MRAM), phase change random access memory (PRAM, aka PCM, PRAM, PCRAM, ovonic unified Memory, chalcogenide random access memory and C-RAM), conductive-bridging random access memory (CBRAM aka. programmable metallization cell or PMC), silicon-oxide-nitride-oxide-silicon (SONOS), resistive random-access memory (RRAM), racetrack memory, nano random access memory (NRAM), millipede, drum memory, magnetic core memory, plated wire memory, bubble memory and twistor memory.

FIG. 2 additionally shows that the auxiliary device 104 can include a battery 214 or other power source. A battery 214 is a device that includes one or more electrochemical cells that convert stored chemical energy into electrical energy. For example, the battery 214 can include a rechargeable battery. A rechargeable battery includes one or more electrochemical cells and its electrochemical reactions are electrically reversible. Rechargeable batteries come in many different shapes and sizes, ranging from button cells to megawatt systems connected to stabilize an electrical distribution network. Several different combinations of chemicals are commonly used, including: lead-acid, nickel cadmium (NiCd), nickel metal hydride (NiMH), lithium ion (Li-ion), and lithium ion polymer (Li-ion polymer).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A negative ion wireless accessory, the negative ion wireless accessory comprising:
an anion emitting ornament; and
an auxiliary device attached to the anion emitting ornament and configured to establish a wireless connection to communicate with an external device.

2. The negative ion wireless accessory of claim 1, wherein the anion emitting ornament includes a wristband.

3. The negative ion wireless accessory of claim 1, wherein the anion emitting ornament includes a necklace.

4. The negative ion wireless accessory of claim 1, wherein the anion emitting ornament is configured to emit more than 2200 ions per cubic centimeter per second on average.

5. The negative ion wireless accessory of claim 1, wherein the negative ion wireless accessory includes rare earth elements.

6. The negative ion wireless accessory of claim 1, wherein the wireless connection includes Bluetooth.

7. The negative ion wireless accessory of claim 1, wherein the wireless connection includes Wi-Fi.

8. A negative ion wireless accessory, the negative ion wireless accessory comprising:
an anion emitting ornament; and
an auxiliary device attached to the anion emitting ornament, wherein the auxiliary devices includes:
a Bluetooth module configured to establish a Bluetooth connection between the auxiliary device and an external device, allowing the auxiliary device to communicate electronically with the external device.

9. The negative ion wireless accessory of claim 8, wherein the auxiliary device includes a caller id.

10. The negative ion wireless accessory of claim 8, wherein the auxiliary device includes a speaker.

11. The negative ion wireless accessory of claim 8, wherein the auxiliary device includes a clock.

12. The negative ion wireless accessory of claim 8, wherein the auxiliary device includes a display.

13. The negative ion wireless accessory of claim 8, wherein the auxiliary device includes a headphone jack.

14. The negative ion wireless accessory of claim 8, wherein the auxiliary device includes a distance indicator.

15. The negative ion wireless accessory of claim 8, wherein the auxiliary device includes a contactless device.

16. The negative ion wireless accessory of claim 8, wherein the auxiliary device includes a phone accessory.

17. The negative ion wireless accessory of claim 8, wherein the auxiliary device includes a microphone.

18. A negative ion wireless accessory for, the negative ion wireless accessory comprising:
an anion emitting ornament; and
an auxiliary device attached to the anion emitting ornament, wherein the auxiliary devices includes:
a Bluetooth module configured to establish a Bluetooth connection between the auxiliary device and an external device, allowing the auxiliary device to communicate electronically with the external device;
an input configured to allow a user to input commands;
a logic device;
a memory; and
a power source.

19. The negative ion wireless accessory of claim 18, wherein the input includes a control array.

20. The negative ion wireless accessory of claim 18, wherein the Bluetooth module includes a Bluetooth low energy (“BLE”) module
